(19) United States
(12) Patent Application Publication
(10) Pub. No.: US 2008/0293027 A1
(43) Pub. Date: Nov. 27, 2008

(54) Method of motivating

(76) Inventor: Michael Gejer, Ambler, PA (US)

Correspondence Address: Michael Gejer, 817 Penllyn Pike, Ambler, PA, 19002, US

(21) Appl. No.: 12/154,101

(22) Filed: May 20, 2008

Related U.S. Application Data
(60) Provisional application No. 60/931,073, filed on May 21, 2007.

(51) Int. Cl. G09B 19/00; G06Q 50/00

(52) U.S. Cl. 434/262; 705/2

(57) ABSTRACT

A method and system for motivating an individual to achieve a goal such as a weight loss goal, is disclosed. An individual sets a weight loss goal. A collector collects a deposit from the individual and takes a first or baseline measurement. The individual attempts to meet the weight loss goal via any means such as dieting, exercise, etc. After a predetermined time, the collector takes a second measurement; preferably the individual's weight. If the individual has met the weight loss goal, at least a portion of the deposit is returned to the individual. If the individual has not met his or her weight loss goal, at least a portion of the deposit is not returned to the individual but is kept by the collector. Additional measurements may be taken at more predetermined times. In addition, individuals may use this system for achieving other goals.

### CROSS-REFERENCE TO RELATED APPLICATIONS

This application claims the benefit of U.S. 60/931,073, filed May 21, 2007 which is incorporated by reference in its entirety.

### FIELD OF THE INVENTION

The invention relates to a method for motivating individuals. In particular, it is a method for motivating individuals to lose weight through financial incentive.

### BACKGROUND

Consumer Weight Loss is a growing multi-billion dollar industry. Millions of people are struggling, desperate or have failed to reach their weight loss and fitness goals. Current trends show the situation is getting worse, and people are losing the battle against obesity.

The industry is flooded with weight loss programs. Most include: proper fitness, controlled diet, and exercise. But most consumers find it difficult to complete these program because they lose their personal motivation along the way. Most current weight loss programs sell a product that is a tool for weight loss, but they do not include the crucial keys to incentive and motivation required for success.

Throughout their lives, people are motivated to accomplish various personal goals by health, money, security, welfare of family/friends, feeling of worth/accomplishment, personal pleasure, etc. People have specific motivators to achieve fitness goals and lose weight as well. The current industry suggests physical appearance, health, and physical fitness as the key factors. Money is not a key promoted motivator in any of the known fitness programs.

There is a need in the industry for better methods of motivating individuals.

### SUMMARY OF THE INVENTION

In one embodiment, the present invention is a method of motivating an individual to achieve a goal such as losing weight. The method comprises collecting a deposit from at least one person, setting a measurable goal for the at least one person, taking a first measurement of the at least one person at a first predetermined time, the measurement relating to the measurable goal, taking a second measurement of the at least one person at a second predetermined time, the measurement relating to the measurable goal, and refunding at least a deposit to the at least one person if the second measurement shows that the at least one person met the measurable goal.

In another embodiment, the present invention is a method of motivating at least one individual to lose weight. The method comprises collecting a monetary deposit from the at least one individual, placing the monetary deposit into an interest bearing account, setting a weight loss goal for the at least one individual, the weight loss goal determined by the at least one individual, weighing the at least one individual at a first predetermined time, weighing the at least one individual at a second predetermined time to determine if the weight loss goal is met, refunding substantially all of the deposit to the at least one individual if the second measurement shows that the at least one individual met the weight loss goal and keeping any interest accrued, and keeping substantially all of the deposit if the second measurement shows that the at least one individual did not meet the weight loss goal.

In yet another embodiment, the present invention is a system for motivating at least one individual to lose weight. The system comprises at least one server computer, and, at least one client computer coupled to the at least one server computer through a network, wherein the at least one server computer includes at least one computer program stored thereon, the at least one computer program being capable of performing the steps of permitting a user stationed at the at least one client computer to select one or more weight loss motivational plans, permitting the user to set a weight loss goal for the at least one individual, permitting the user to negotiate a contract with a collector, permitting the user to submit a deposit, permitting the user to submit a first measurement taken at a first predetermined time, permitting the user to submit a second measurement taken at a second predetermine time, permitting the user collect at least a portion of the deposit if the second measurement shows that the at least one person met the measurable goal.

### BRIEF DESCRIPTION OF THE DRAWINGS

For the purpose of illustrating the invention, there is shown in the drawings a form which is presently preferred; it being understood, that this invention is not limited to the precise arrangements and instrumentalities shown.

FIG. 1 is a flow diagram showing a method for motivating.

FIG. 2 is a client-server model comprising a website featuring a method of motivating.

FIG. 3 is a map of a website that may be used in conjunction with the method of motivating.

### DETAILED DESCRIPTION OF THE DRAWINGS

In the figures, where like reference numerals indicate like elements, there is shown a method of motivating 10. In one embodiment, a consumer or user (or at least one individual who wants to achieve a goal in a predetermined amount of time) requests a consultation 12 from a collector. The individual may request a consultation via any known communication means including telephone, internet, by mail, fax, etc. He or she then has the initial consultation 14. The consultation may take place via telephone, internet, mail, etc. During the initial consultation, the individual and the collector discuss the individual's goals, which is explained below. Once the collector and the user agree to terms, including the user's goals, milestones, amount of deposit to be paid, time for completing goals, penalties for not completing goals within agreed-upon time, the collector and the user sign a contract 16 whereupon the program begins. The collector then collects the agreed-upon deposit 18 from the user. The collector puts the deposit into an account (not shown), which may be virtually any type of account known in the art, including a bank account, mutual fund, safe deposit box, etc. The collector records (not shown) the goal and length of the predetermined time. In the preferred embodiment, the deposit is money; however, it may be anything of value to either the individual or collector. The deposit may be given by any means including, but not limited to a direct deposit, cash, check, credit card, etc. The deposit may be collected at one time or, payment plans may be set up whereby the collector collects portions of the deposit at predetermined intervals. the deposit if the second measurement shows that the at least one person met the measurable goal.

### BRIEF DESCRIPTION OF THE DRAWINGS

For the purpose of illustrating the invention, there is shown in the drawings a form which is presently preferred; it being understood, that this invention is not limited to the precise arrangements and instrumentalities shown.

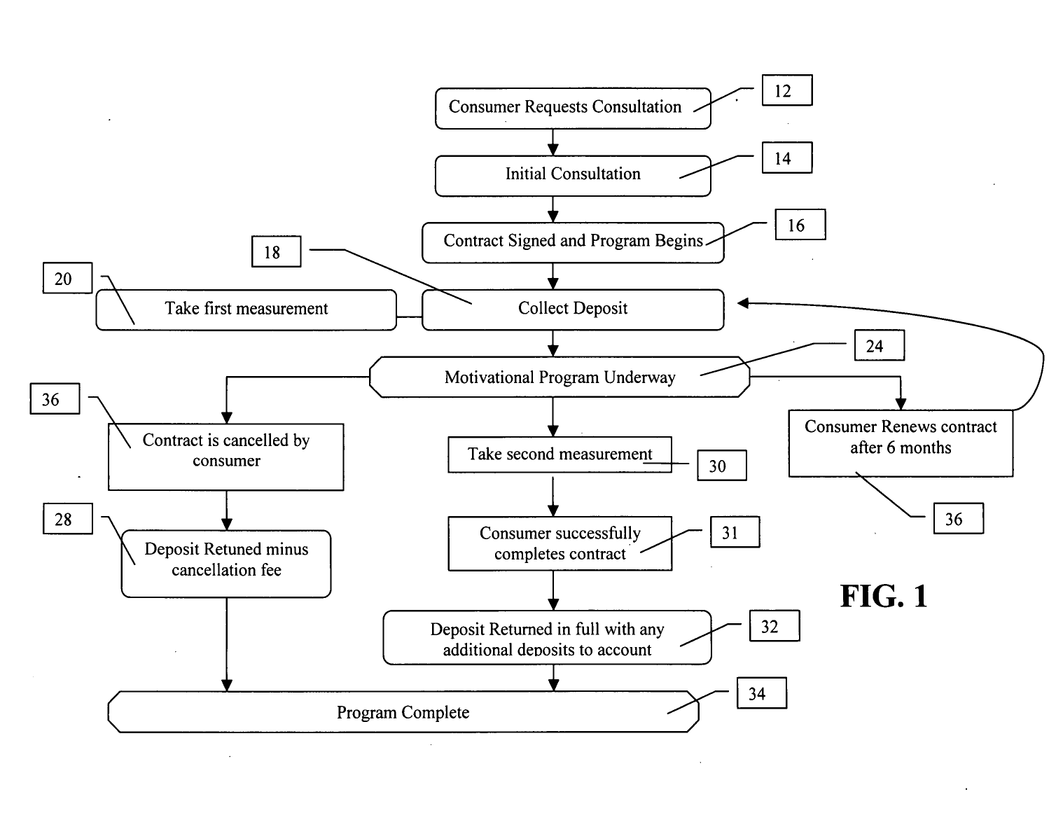

FIG. 1 is a flow diagram showing a method for motivating.

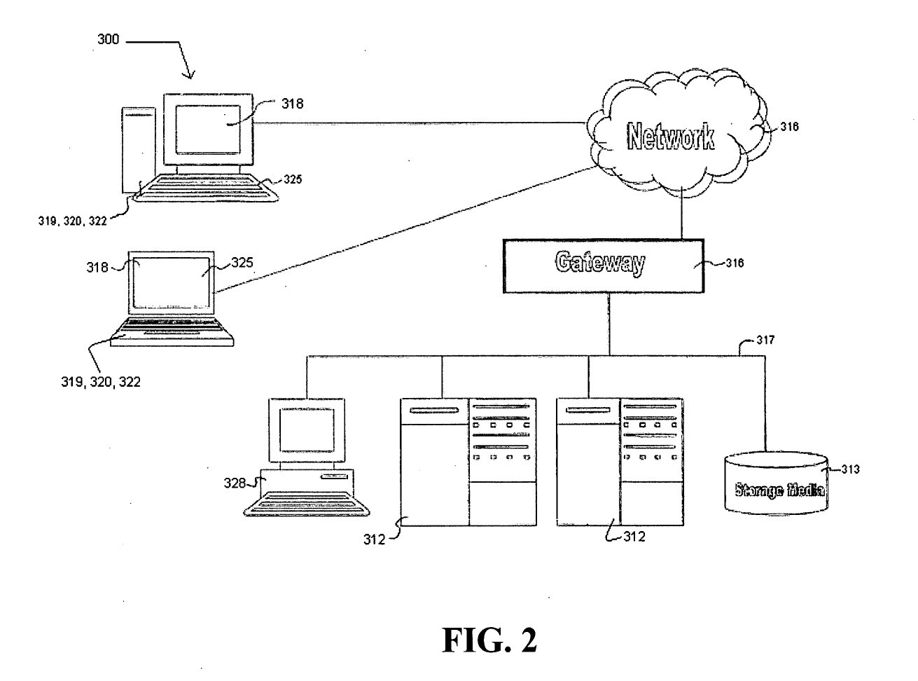

FIG. 2 is a client-server model comprising a website featuring a method of motivating.

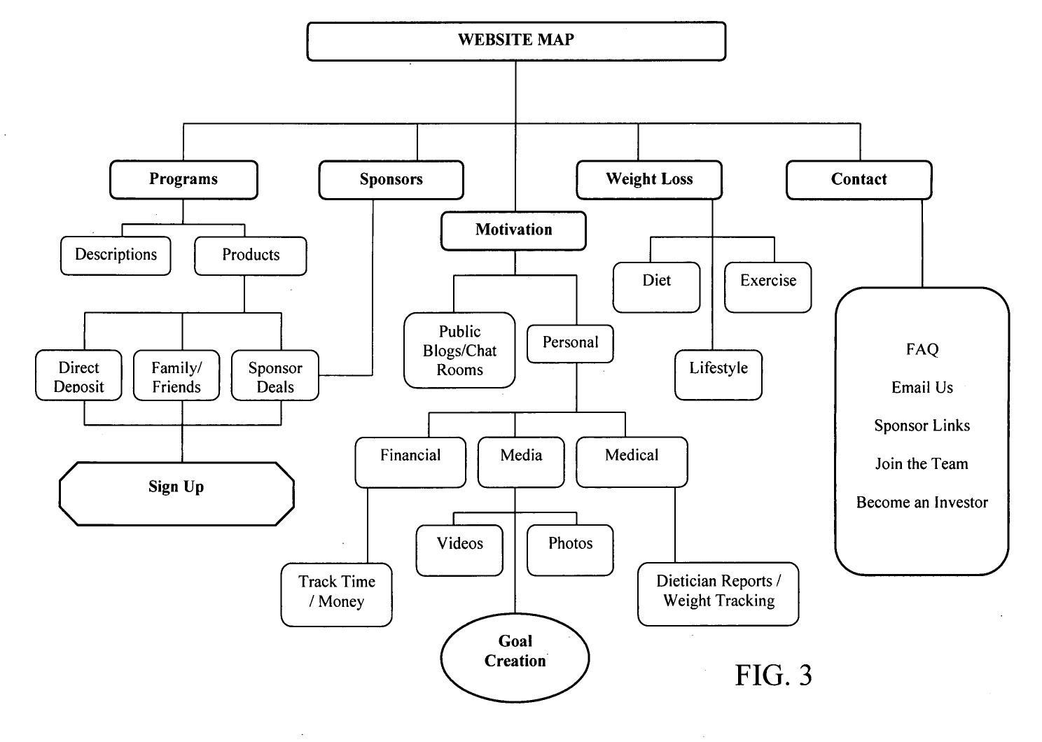

FIG. 3 is a map of a website that may be used in conjunction with the method of motivating.

### DETAILED DESCRIPTION OF THE DRAWINGS

In the figures, where like reference numerals indicate like elements, there is shown a method of motivating 10. In one embodiment, a consumer or user (or at least one individual who wants to achieve a goal in a predetermined amount of time) requests a consultation 12 from a collector. The individual may request a consultation via any known communication means including telephone, internet, by mail, fax, etc. He or she then has the initial consultation 14. The consultation may take place via telephone, internet, mail, etc. During the initial consultation, the individual and the collector discuss the individual's goals, which is explained below. Once the collector and the user agree to terms, including the user's goals, milestones, amount of deposit to be paid, time for completing goals, penalties for not completing goals within agreed-upon time, the collector and the user sign a contract 16 whereupon the program begins. The collector then collects the agreed-upon deposit 18 from the user. The collector puts the deposit into an account (not shown), which may be virtually any type of account known in the art, including a bank account, mutual fund, safe deposit box, etc. The collector records (not shown) the goal and length of the predetermined time. In the preferred embodiment, the deposit is money; however, it may be anything of value to either the individual or collector. The deposit may be given by any means including, but not limited to a direct deposit, cash, check, credit card, etc. The deposit may be collected at one time or, payment plans may be set up whereby the collector collects portions of the deposit at predetermined intervals.

In the preferred embodiment, the goal is losing a predetermined amount of weight in a predetermined amount of time. However, one of skill in the art will realize that any measurable goal may be used, for example, lowering cholesterol or blood pressure, working more or less hours, stopping smoking, etc. Proximate in time to providing the deposit, at least one measurement 20 is taken of the at least one person at a first time. In one embodiment, the person is weighed. This weight is recorded. In one embodiment, the at least one person is given a physical by a licensed doctor 22.

The Motivational Program then begins 24. In particular, the at least one person then begins to try to meet the predetermined goal. He or she may attempt to meet the goal by virtually any means. These include, but are not limited to, Weight Loss Programs, Gyms, Dieticians, Nutritionists, therapists, etc. These methods must not endanger the health of the person. A dietician or physician may oversee this issue. At this time, friends, family members, and others may deposit funds into the program, namely, the deposit account, to further motivate the individual to achieve his or her goal(s). As provided in more detail below, the initial deposit, including any additional funds provided by third parties, the individual, or the collector shall be available to the person only if the predetermined goal is successfully reached. These deposits may be given by any means including, but not limited to a direct deposit, cash, check, etc.

If the at least one person cancels the program 26 before the predetermined time expires, the collector retains an agreed-upon portion (for example, a cancellation fee) of the deposit, retains any interest or other income generated by the account, and returns the deposit minus this cancellation fee 28 and the program is complete 34. In one embodiment, this is 100% of the deposit and the collector keeps the interest. However, in other embodiments, the amount that the collector retains is variable depending upon the length of time that has elapsed since the predetermined time began and whether the individual has met any portion of his or her goal, for example, the amount of weight lost,.

If the at least one person does not cancel the program, a second measurement is taken 30 at the end of a predetermined time. In the preferred embodiment, the at least one person is weighed. That weight is recorded. If the person met his or her goal 31, at least a portion of the deposit is returned 32, minus any interest or other fees accrued during the predetermined time and the program is complete 34. In one embodiment, the entire deposit is returned by the collector to the individual. However, in other embodiments, the amount is variable. In other embodiments, additional valuable goods and services are provided if the person meets his or her goals. These goods include, but are not limited to clothing, vacations, fitness equipment, sports equipment, etc. These additional goods and services may be provided by the collector, third parties or sponsors.

It is also possible that the user will not complete the program successfully but will renew the contract 36 after a predetermined or variable time; for example, six (6) months. If so, the collector and user negotiate another contract and the program resumes as provided above.

The collector and the at least one person and, in some cases, third parties such as attorneys, family members, etc. may agree upon any deposit, predetermined times, goals, etc. In one embodiment, collector returns 100% of the deposit if the agreed-upon weight loss goal is met. A variable cancellation fee of approximately 25% is charged if the individual cancels the program before he or she reaches the goal or, if the individual does not meet the measured goal at the predetermined time. For example, a user may set a weight loss goal of twenty (20) pounds and may have lost that weight at some point during the program but gain it back before the measurement at the predetermined time. Further, the contract may specify a number of different “plans”, a “Silver Plan”—$1000-$2499 investment/40% Cancel Fee/$100 renewal fee @6 mo, “Gold Plan”—$2500-$5000 investment/30% Cancel Fee/$50 renewal fee @6 mo, “Platinum Plan”—$5001-$10K investment/25% Cancel Fee/$25 renewal fee @6 mo, “Platinum Plus Plan” →$10,000 investment/Variable Cancel Fee/No Renewal Fees. In other embodiments, the parties may set virtually any predetermined time for meeting the goal. Thus, the time may be set by the collector, the at least one person, or a third party.

In other embodiments, there may be more than just two (2) predetermined times. For example, a second measurement may be taken at a second predetermined time and a third may be taken at a third predetermined time. The collector and individual will decide at what predetermined time the final measurement is taken (i.e., the one that determines whether the goal is met.) Preferably, periodic physicals or other medical examinations are given at specified intervals. In addition, measurements may be taken before the predetermined times, for example, at a mid-way point between the predetermined times. If the person has met a mid-point goal as of the second measurement, a portion of the deposit or other funds in the person's account may be given to the person.

The collector returns the deposit if the individual meets his or her fitness goals, as measured at the final predetermined time. If the individual fails to meet the goal, for example, if he or she did not lose the agreed-upon amount of weight, the collector will keep some or all of the deposit and, possibly, any other funds that are in the individual's account. In another embodiment, the collector refunds the deposit and any money in the individual's account if he or she meets the goal. In another embodiment, another measurement may be taken at a predetermined time occurring at the final predetermined time (i.e., the predetermined date at which the program ends.) If the at least one person has not maintained the goal (i.e., has not kept his or her weight at the goal amount), the at least one person returns a portion of the money in the account.

In other embodiments, varying weight loss schedules and time limits are available if desired (with other penalties involved). A small, nonrefundable registration fee required to join the program, renewal registration fees may be applied every six (6) months. Initial and follow-up physicals and monthly dietician support is required during the contract duration.

In one embodiment, the collector and the at least one person, and/or third parties memorialize the terms of the above in a contract. The contract may be executed at any time, but is preferably executed proximate in time to taking the deposit. At a minimum, the contract provides that the at least one person gives the deposit to the collector and if the at least one person fails to meet the predetermined goal within the predetermined time or cancels, i.e., “drops out” of the program, the collector keeps at least a portion of the deposit.

FIG. 2 shows a client-server computer system according to a second exemplary embodiment of the present invention, and a method of using the same. The system 300 preferably includes at least one computer software program (not shown) for carrying out the features of the invention. The computer software program is preferably available for download from a network, or available over a network for real time use.

FIG. 2 shows a client-server computer system 300 according to the second exemplary embodiment of the present invention which may be utilized to download the virtual system or use it in real time on a web page, over a network 316 and to carry out a method. The computer system 300 includes a plurality of server computers 312 and a plurality of user computers 325 (clients) and at least one workstation 328 and a storage media 313. The storage media 313 and work station 328 are optional. The server computers 312 comprise software (not shown) for communicating with user computers 325; for example, receiving requests from server computers' 312 web browsers, processing and in some cases, accessing the storage media 313, and responding to the request. One or more of the server computers 312 may comprise a daemon server. One or more of the server computers 312 preferably include at least one computer program for permitting the method 300 to be performed.

The user computers 325 may comprise any microprocessor controlled device that permits access to the network 316, including personal computers, workstations, servers, laptop computers, etc. Each of the user computers preferably include storage media (not shown), as is known in the art. The server computers and the user computers may be connected by a network such as for example, an Intranet or the Internet. The user computers may be connected to the network by a dial-up modem connection, a Local Area Network (LAN), a Wide Area Network (WAN), cable modem, digital subscriber line (DSL), or other equivalent connection means (whether wired or wireless). The servers 312 and a storage media and workstation may be interconnected by a LAN, which is coupled to a gateway 326. The gateway facilitates access to the server computers, workstation and storage media. In one embodiment, the LAN conforms to the Transmission Control Protocol (TCI/IP).

In a preferred embodiment, the server computers comprise a website related to the method of motivating. Each user computer preferably includes a video monitor 318 or display for displaying information from the website. Additionally, each user computer preferably includes an electronic mail (e-mail) program 319 (e.g., Microsoft Outlook®) and a browser 320 program (e.g. Microsoft Internet Explorer®, Netscape Navigator®, etc.), as is well known in the art.

One or more of the server computers preferably include a program module (explained in detail below) which allows the user computers to communicate with the server computers and each other over the network. The program module 322 may include program code, preferably written in Hypertext Mark-up Language (HTML), JAVA™ (Sun Microsystems, Inc.), Active Server Pages (ASP), Extensible Markup Language (XML), and/or any other such software language known to those of ordinary skill in the art, which allows the user computers to access the program module through browsers (i.e., by entering a proper Uniform Resource Locator (URL) address).

The exemplary program module preferably includes program code for facilitating a method of motivating among the server computers and user computers, as explained in detail below. As explained in more detail below, and in FIG. 3, the program code is preferably capable of providing a web page (i.e., GT Motivation, http://www.gtmotivation.com/, GTMo, etc.) to one or more user computer, permitting accessing of a database (e.g., database) containing information regarding the user's weight loss plan. The website describes the program, options, etc. It provides means for joining the program and communicating with the collector. The website also has means for tracking a user's progress; i.e., how much time has passed/is left in the program in relation to the amount of weight that the user has lost. In that regard, hardware may be coupled to the user computer. Such hardware may include a digital scale that transmits a user's weight via the user's computer, to the server computer. The user computer may also include hardware for identifying the individual, for example a biometric scanner. The website also allows the user to view the funds in his or her deposit account, and allows persons to make deposits to selected accounts, etc. The website allows for personal goal creation and goal evolution. Motivational support is also provided via the website; for example, video, audio, and written messages from the consumer, industry experts, the program owner, friends, family, etc. Sponsors may be included on the website; for example, Weight loss Industry members, Fitness Centers, Dieticians, etc. The website allows for public and group chat rooms and blog pages. The website allows for consumer frequently asked questions and investment opportunities.

At least one of the server computers 312 also includes a storage media or database 313 for storing information utilized by the program module.

The present invention provides many advantages. The present invention sells motivation to the consumer by incorporating money as a motivator to achieve their fitness goals. The industry will continue to grow, but consumers will ultimately look for motivational aids after repeated failures and continued pressure to achieve goals. The present invention supplements and strengthens the existing weight loss programs available.

The present invention will allow the consumer to continue using whatever program they find most effective. Our program adds additional motivation that will keep the consumer focused on the plan that they belong to. In a preferred embodiment, the present invention utilizes a website as the basis of for the services.

The company will be a powerful team of motivational experts and professionals, spreading our message throughout the country and across the globe. In time, our program will evolve and expand beyond the world of weight loss into a multitude of other areas where society is in need of motivational support in order to achieve its goals.

I claim:

1. A method of motivating comprising:
collecting a deposit from at least one person;
setting a measurable goal for the at least one person;
taking a first measurement of the at least one person at a first predetermined time, the measurement relating to the measurable goal;
taking a second measurement of the at least one person at a second predetermined time, the measurement relating to the measurable goal; and
refunding at least a portion of the deposit to the at least one person if the second measurement shows that the at least one person met the measurable goal.

2. The method of claim 1 wherein the deposit is monetary.

3. The method of claim 1 wherein the first and second measurements are the weight of the at least one person.

4. The method of claim 1 wherein the first and second measurements are the circumference of the at least one person's waist.

5. The method of claim 1 further comprising waiting at least one week between the first and second measurements.

6. The method of claim 1 further comprising waiting at least six months between the first and second measurements.

7. The method of claim 1 wherein the refund is substantially a full refund of the entire deposit amount.

8. The method of claim 1 wherein the at least one person determines the amount of the deposit.

9. The method of claim 1 further comprising at least one second person, wherein the at least one second person contributes to the deposit.

10. The method of claim 1 further comprising keeping substantially the entire deposit if the goal is not met.

11. The method of claim 1 further comprising refunding a portion of the deposit to the at least one person if the at least one person stops pursuing the goal before the second predetermined time.

12. The method of claim 1 further comprising taking a third measurement of the at least one person at a third predetermined time, the third predetermined time occurring after the second predetermined time and wherein the third measurement is related to the goal.

13. The method of claim 2 wherein the amount of the deposit is related to the goal.

14. A method of motivating at least one individual to lose weight, the method comprising:
collecting a monetary deposit from the at least one individual;
placing the monetary deposit into an interest bearing account;
setting a weight loss goal for the at least one individual, the weight loss goal determined by the at least one individual;
weighing the at least one individual at a first predetermined time;
weighing the at least one individual at a second predetermined time to determine if the weight loss goal is met;
refunding substantially all of the deposit to the at least one individual if the second measurement shows that the at least one individual met the weight loss goal and keeping any interest accrued; and
keeping substantially all of the deposit if the second measurement shows that the at least one individual did not meet the weight loss goal.

15. The method of claim 14 wherein the amount of the deposit is proportionate to the weight loss goal.

16. A system for motivating at least one individual to lose weight, the system comprising:
at least one server computer; and, at least one client computer coupled to the at least one server computer through a network;
wherein the at least one server computer includes at least one computer program stored thereon, the at least one computer program being capable of performing the steps of:
permitting a user stationed at the at least one client computer to select one or more weight loss motivational plans;
permitting the user to set a weight loss goal for the at least one individual;
permitting the user to negotiate a contract with a collector;
permitting the user to submit a deposit;
permitting the user to submit a first measurement taken at a first predetermined time;
permitting the user to submit a second measurement taken at a second predetermine time;
permitting the user collect the deposit if the second measurement shows that the at least one individual met the measurable goal.

17. The system of claim 16 further comprising a scale coupled to the client computer, the scale configured to electronically transmit a weight measurement to the server computer.
